(19) United States
(12) Patent Application Publication
(10) Pub. No.: US 2024/0417197 A1
(43) Pub. Date: Dec. 19, 2024

(54) PAPER SHEET STORAGE DEVICE

(71) Applicant: FUJITSU FRONTECH LIMITED, Tokyo (JP)

(72) Inventors: Yanan LAN, Inagi (JP); Tomoyuki MIYAZAWA, Inagi (JP); Makoto TAKAYAMA, Inagi (JP); Takashi WATANABE, Inagi (JP)

(73) Assignee: FUJITSU FRONTECH LIMITED, Tokyo (JP)

(21) Appl. No.: 18/818,155

(22) Filed: Aug. 28, 2024

Related U.S. Application Data
(63) Continuation of application No. PCT/JP2022/011429, filed on Mar. 14, 2022.

(51) Int. Cl. B65H 1/24; B65H 29/14; G07D 11/13

(52) U.S. Cl. CPC B65H 1/24; B65H 29/145; G07D 11/13; B65H 2404/2614; B65H 2701/1912

(57) ABSTRACT

According to an aspect of an embodiment, a paper sheet storage device includes a holding member that includes a loading region into which a paper sheet is loaded; a storing member that is disposed adjacent to the holding member and that is used to store the paper sheet; a carrier unit that, in a state in which at least a single pair of carrier belts is abutting against both sides of the paper sheet, carries the paper sheet into the loading region; and a pressing mechanism that presses the paper sheet, which has been carried into the loading region, inside the storing member. In the paper sheet storage device, at the time of pressing of the paper sheet by the pressing mechanism, the carrier unit releases the abutment of one of the carrier belts with respect to the paper sheet.

### CROSS-REFERENCE TO RELATED APPLICATION(S)

This application is a continuation of International Application No. PCT/JP2022/011429, filed on Mar. 14, 2022, the entire contents of which are incorporated herein by reference.

### FIELD

The embodiment discussed herein is related to a paper sheet storage device.

### BACKGROUND

In a bank bill handling device such as an automated teller machine (ATM), a bank bill storage device meant for storing and accumulating the bank bills is included so that the deposited bank bills can be eventually collected from the bank bill handling device. Regarding such bank bill storage devices, a conventional technology is known by which the bank bills stacked only after smoothing out the wrinkles.
[Patent Literature 1] Japanese Laid-open Patent Publication No. 61-23072
[Patent Literature 2] Japanese Laid-open Patent Publication

However, in the conventional technology mentioned above, the bank bills get stacked only because of their own weight, and there are times when the bank bills not having any deformation, such as wrinkles, are not systematically stored without leaving any space therebetween.

### SUMMARY

According to an aspect of an embodiment, a paper sheet storage device includes a holding member that includes a loading region into which a paper sheet is loaded; a storing member that is disposed adjacent to the holding member and that is used to store the paper sheet; a carrier unit that, in a state in which at least a single pair of carrier belts is abutting against both sides of the paper sheet, carries the paper sheet into the loading region; and a pressing mechanism that presses the paper sheet, which has been carried into the loading region, inside the storing member. In the paper sheet storage device, at the time of pressing of the paper sheet by the pressing mechanism, the carrier unit releases the abutment of one of the carrier belts with respect to the paper sheet.

### BRIEF DESCRIPTION OF DRAWINGS

FIG. 1 is a schematic diagram illustrating, in entirety, a bank bill handling device that includes a bank bill storage device according to an embodiment;

FIG. 2 is a perspective view illustrating the bank bill storage device according to the embodiment;

FIG. 3 is a planar view of the bank bill storage device according to the embodiment;

FIG. 4A is a perspective view illustrating the state in which a pressing member is at a standby position in the bank bill storage device according to the embodiment;

FIG. 4B is a perspective view illustrating the state in which the pressing member has moved to a temporary accumulation region in the bank bill storage device according to the embodiment;

FIG. 4C is a perspective view illustrating the state in which the pressing member has moved inside a storage compartment in the bank bill storage device according to the embodiment;

FIG. 5A is schematic diagrams illustrating a lateral face of a carrier unit in the bank bill storage device according to the embodiment;

FIG. 5B is schematic diagrams illustrating a lateral face of a carrier unit in the bank bill storage device according to the embodiment;

FIG. 6A is schematic diagrams illustrating the top face of the carrier unit in the bank bill storage device according to the embodiment; and

FIG. 6B is schematic diagrams illustrating the top face of the carrier unit in the bank bill storage device according to the embodiment; and

FIG. 7 is a schematic diagram illustrating the bottom face portion of the carrier unit in the bank bill storage device according to the embodiment.

### DESCRIPTION OF EMBODIMENT

An exemplary embodiment of a bank bill storage device according to the application concerned is described in detail with reference to the accompanying drawings. However, the bank bill storage device according to the application concerned is not limited by the embodiment described below.

### Configuration of Bank Bill Handling Device

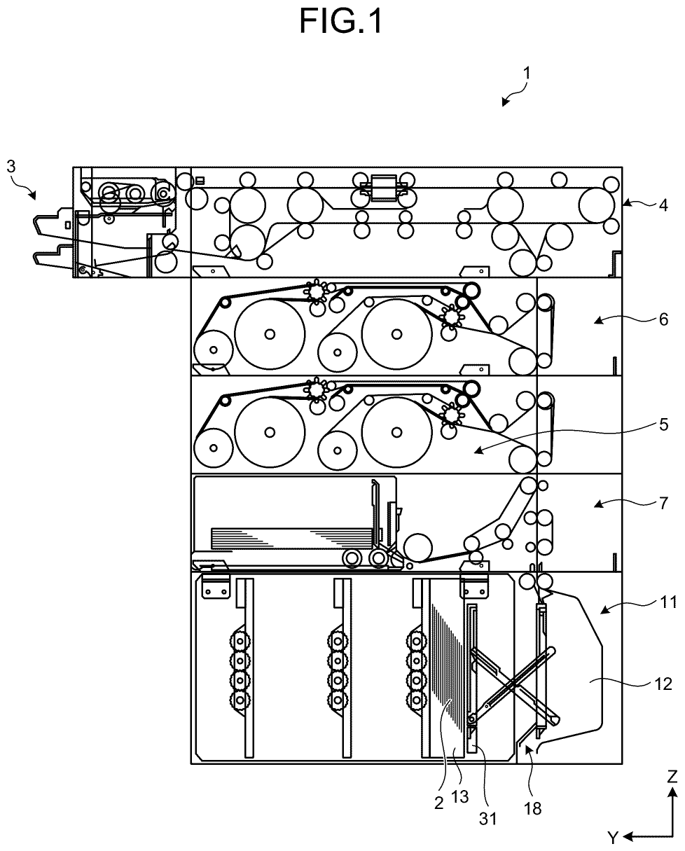

FIG. 1 is a schematic diagram illustrating, in entirety, a bank bill handling device that includes the bank bill storage device according to the embodiment. In the drawings, the X axis and the Y axis (the front-back direction of the bank bill storage device) represent the horizontal direction, and the Z axis represents the vertical direction.

As illustrated in FIG. 1, a bank bill handling device 1 includes: a deposit-withdrawal unit 3 that is used for depositing or withdrawing a bank bill 2; a validating unit 4 that validates the bank bill 2 deposited in the deposit-withdrawal unit 3; and a temporary holder 5 that is used to temporarily hold the bank bill 2 which has been carried from the validating unit 4. Moreover, the bank bill handling device 1 includes a back-flow unit 6 that causes the bank bill 2, which is held in the temporary holder 5, to move backward; a withdrawal unit 7 in which the withdrawn bank bill 2 is held; and a bank bill storage device 11 that stores the bank bill 2 in a storage compartment 13. Herein, the bank bill storage device 11 that is embedded in the bank bill handling device 1 corresponds to a paper sheet storage device. In the present embodiment, although the bank bill 2 is treated as an example of a paper sheet, a paper sheet is not limited to a bank bill.

### Configuration of Bank Bill Storage Device

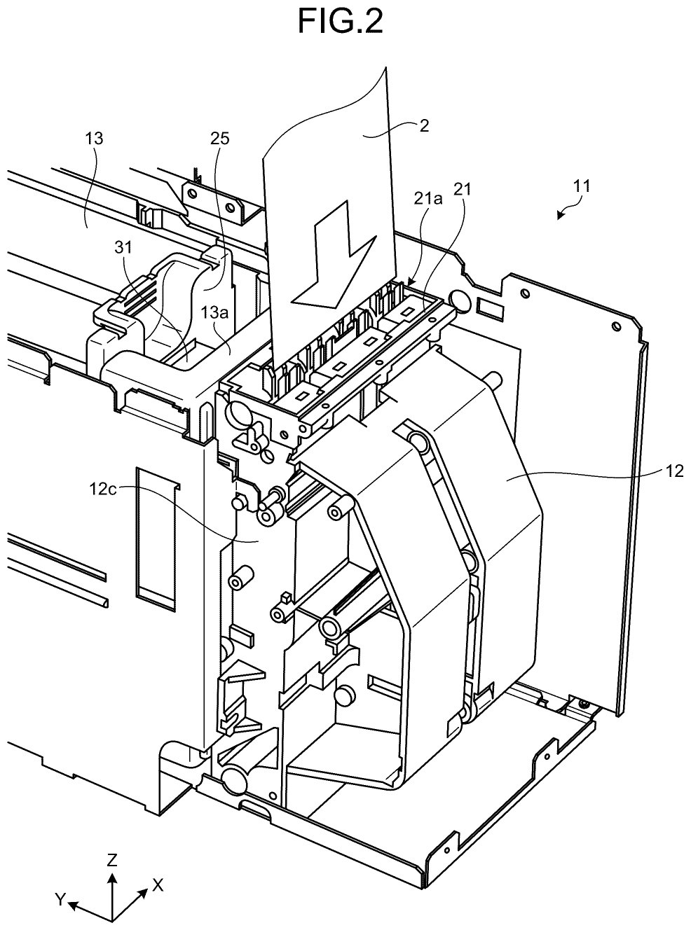

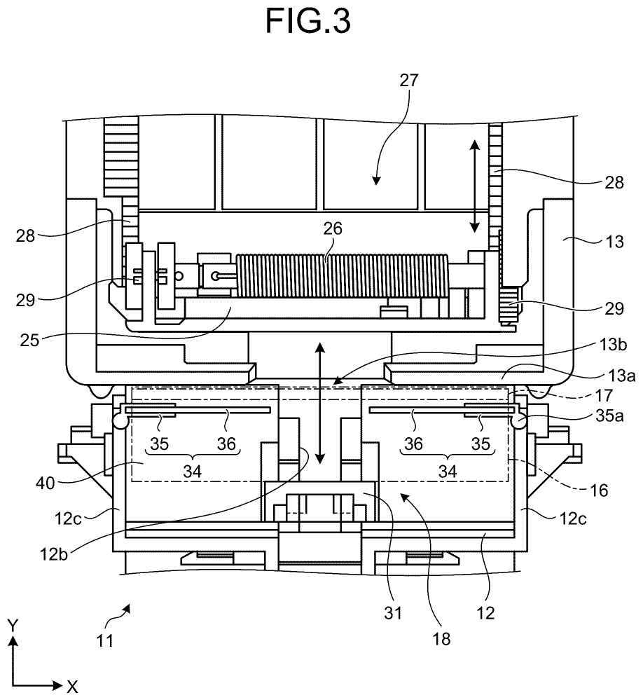

FIG. 2 is a perspective view illustrating the bank bill storage device 11 according to the embodiment. FIG. 3 is a planar view of the bank bill storage device 11 according to the embodiment.

As illustrated in FIGS. 2 and 3, the bank bill storage device 11 according to the embodiment includes a holding member 12; a storage compartment 13 serving as a storage member; a temporary accumulation region 17; a pressing mechanism 18; and a carrier unit 40. The holding member 12 includes a loading region 16 in which the bank bill 2 gets loaded. The storage compartment 13 is disposed adjacent to the holding member 12 in the Y direction, and is used to store the bank bill 2. The temporary accumulation region 17 is provided in between the loading region 16 and the storage compartment 13, and is used to temporarily accumulate the bank bill 2 that is to be stored in the storage compartment 13. The pressing mechanism 18 presses the entire bank bill 2, which has been loaded in the loading region 16, into the temporary accumulation region 17; and presses a plurality of bank bills 2, which is accumulated only in the temporary accumulation region 17, inside the storage compartment 13. In the carrier unit 40, at least a single pair of carrier belts abuts against both sides of the bank bill 2 and, in that abutted state, carry the bank bill 2 to the loading region 16 (the detailed explanation is given later). Meanwhile, alternatively, the pressing mechanism 18 can press the bank bill 2, which is loaded in the loading region 16, into the storage compartment 13 without accumulating it in the temporary accumulation region 17.

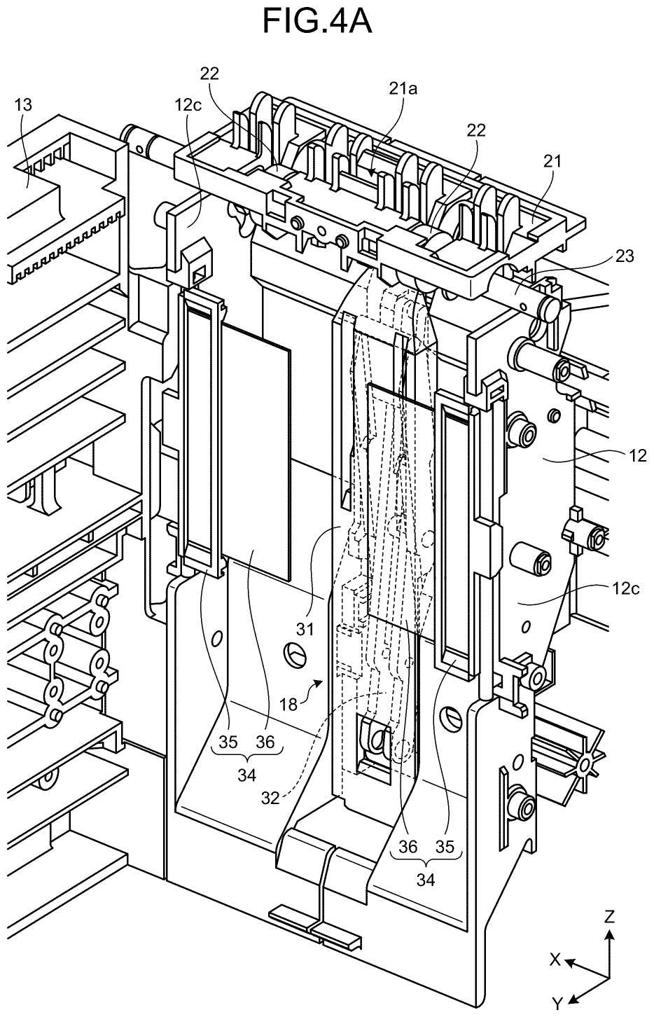

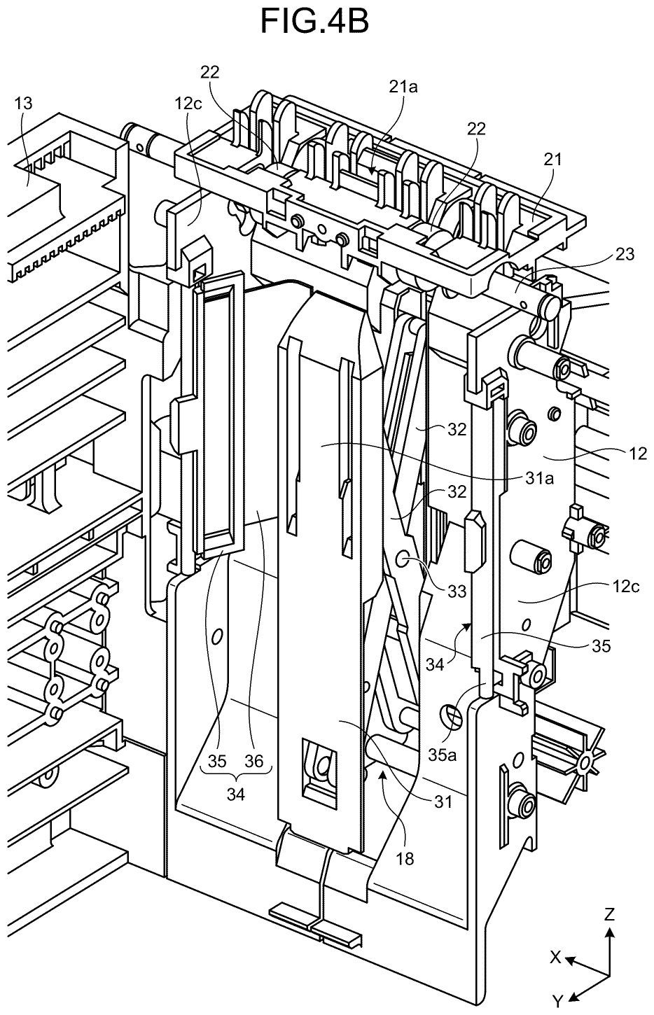

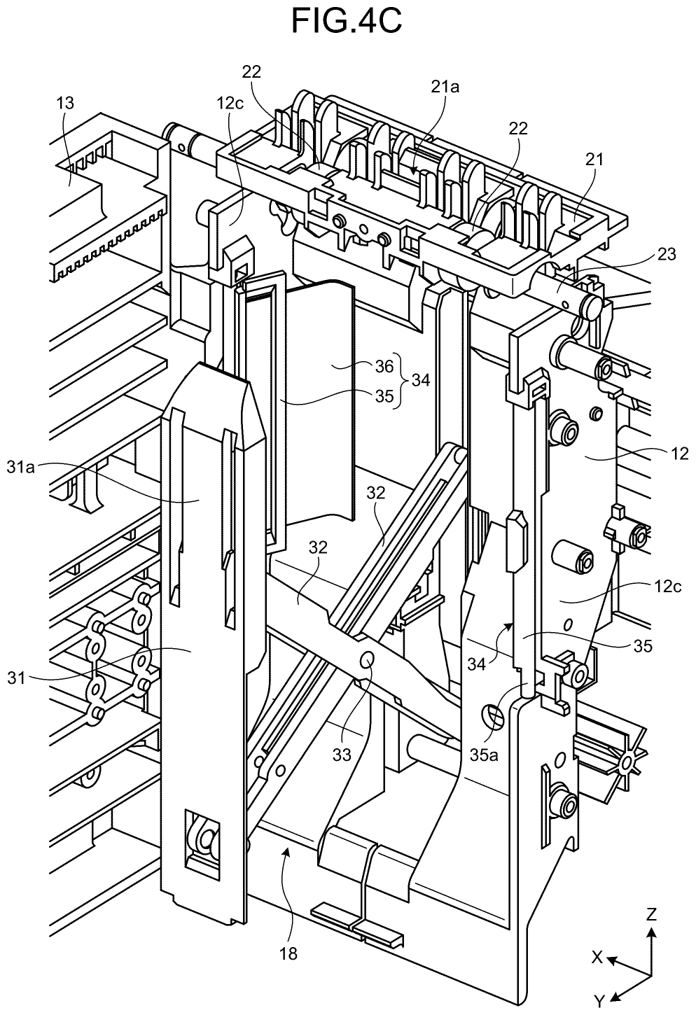

As illustrated in FIGS. 2 and 3, in the holding member 12, the space constituting the loading region 16, in which the bank bill 2 is loaded, is formed in a substantially box-like shape neighboring a storage opening 13b of the storage compartment 13 (explained later). Meanwhile, the loading region 16 has the carrier unit 40 installed therein. On the vertically upward side of the holding member 12, a guiding member 21 is disposed on which a loading opening 21a is formed for loading the bank bill 2. At the loading opening 21a of the guiding member 21, a plurality of guide rollers 22 (see FIG. 4A) is provided for guiding the bank bill 2. The guide rollers 22 that are provided on one side of the loading opening 21a are fixed to a spindle 23 and are rotated via the spindle 23 (see FIG. 4A).

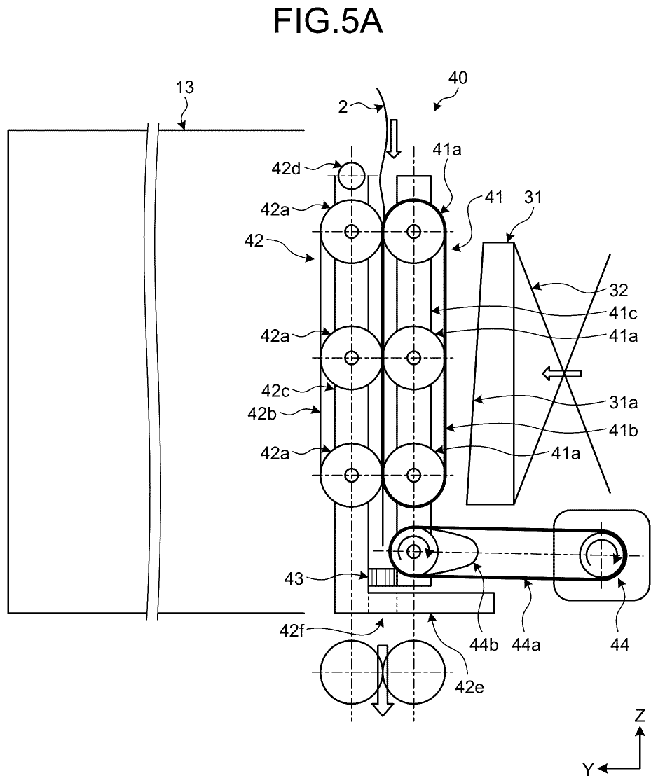

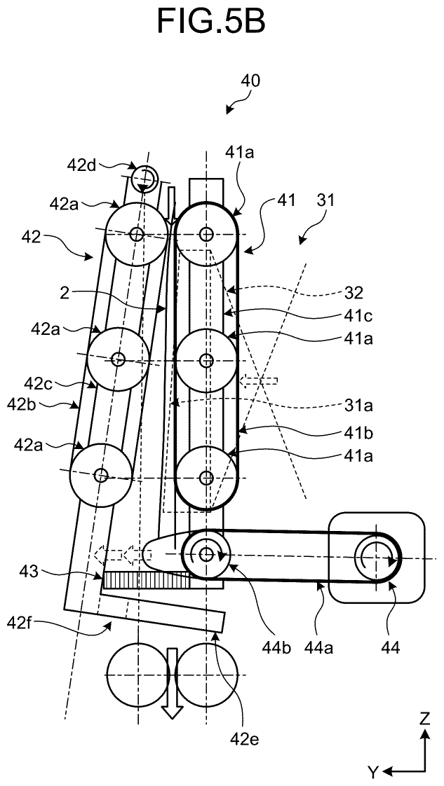

For example, with its long side kept parallel to the horizontal direction, the bank bill 2 is carried from the vertically upward side toward the guiding member 21 present on the lower side, and is sent to the holding member 12 from the loading opening 21a by the guide rollers 22. After being sent to the holding member 12, the bank bill 2 is loaded into the loading region 16 by the carrier unit 40. In the loading region 16 of the holding member 12, the carrier unit 40 (see FIG. 5A) is disposed that, in the state in which at least a single pair of carrier belts (41b and 42b) is abutting against both sides of the bank bill 2, carries the bank bill 2 sent thereto through the loading opening 21a present in the upper side.

The temporary accumulation region 17 is provided in the holding member 12 and neighboring the loading region 16. In the present embodiment, although the holding member 12 has the temporary accumulation region 17 provided therein, that is not the only possible configuration. Alternatively, a temporary accumulation member having the temporary accumulation region 17 provided therein can be disposed as an independent member in between the holding member 12 and the storage compartment 13.

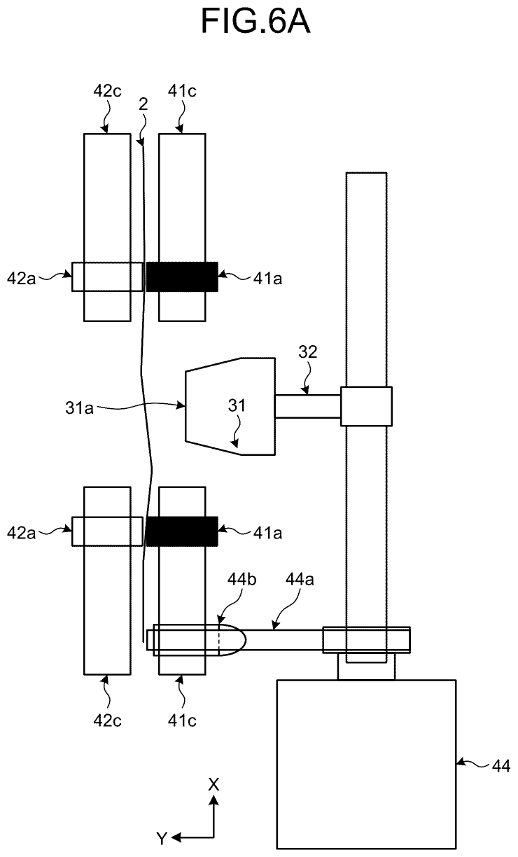

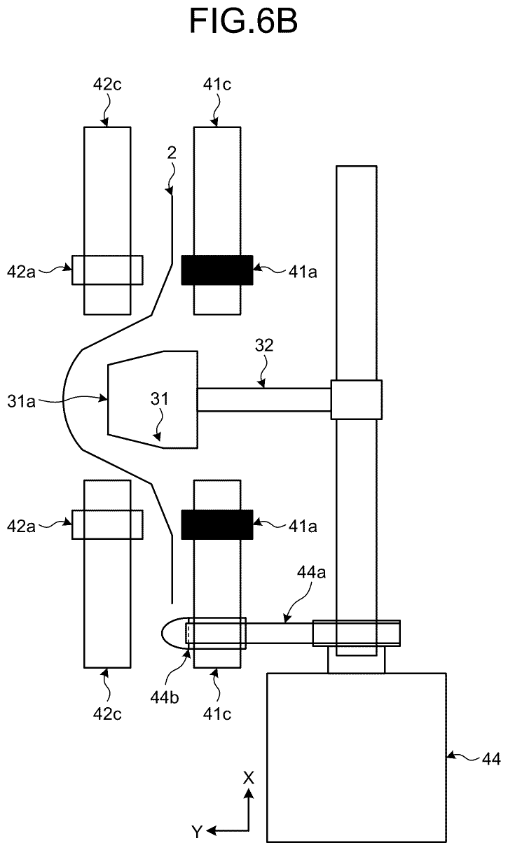

As illustrated in FIGS. 2 and 3, the storage compartment 13 is formed as a box-type compartment having a substantially rectangular parallelopiped shape, and is disposed in a detachably-attachable manner with respect to the bank bill handling device 1. Thus, after a predetermined quantity of bank bills 2 gets stored therein, the storage compartment 13 is taken out from the bank bill handling device 1 and the bank bills 2 are collected. The storage compartment 13 has a side wall 13a adjacent to the temporary accumulation region 17 of the holding member 12. At the center of the side wall 13a is provided the storage opening 13b through which the bank bill 2, which is carried from the temporary accumulation region 17, is pressed. The dimensions of the storage opening 13b are smaller than the external dimensions of the bank bill 2. At the time of getting stored in the storage compartment 13 through the storage opening 13b, the bank bill 2 is folded into two at the center in the long side direction and thus becomes smaller in the outer shape (see FIG. 6B). In such a folded state, the bank bill 2 is pressed against the storage opening 13b, and thus gets stored inside the storage compartment 13 through the storage opening 13b. Since the storage opening 13b is formed to be smaller than the outer shape of the bank bill 2, the bank bill 2 that is stored inside the storage compartment 13 is prevented from falling out through the storage opening 13b.

Meanwhile, with the aim of accumulating the bank bill 2 that was stored through the storage opening 13b, the storage compartment 13 includes a pressing member 25 that presses the bank bill 2 against the side wall 13a. The pressing member 25 is formed to have a size that enables pressing of the bank bill 2 across the long side direction. Moreover, the pressing member 25 is biased toward the side wall 13a by a coil spring 26. Furthermore, the storage compartment 13 includes a guiding mechanism 27 that movably guides the pressing member 25 in the direction of approaching and moving away from the side wall 13a of the storage opening 13b. The guiding mechanism 27 includes: a pair of guide rails 28 formed along the direction of approaching and moving away from the side wall 13a; and a gear 29 that moves along the guide rails 28. The pressing member 25 is disposed across the pair of guide rails 28 via the gear 29.

### Configuration of Pressing Mechanism

FIG. 4A is a perspective view illustrating the state in which a pressing member is at a standby position in the bank bill storage device 11 according to the embodiment. FIG. 4B is a perspective view illustrating the state in which the pressing member has moved to the temporary accumulation region 17 in the bank bill storage device 11 according to the embodiment. FIG. 4C is a perspective view illustrating the state in which the pressing member has moved inside the storage compartment 13 in the bank bill storage device 11 according to the embodiment.

As illustrated in FIGS. 4A, 4B, and 4C, the pressing mechanism 18 includes: a pressing member 31 meant for pressing the bank bill 2, which has been loaded into the loading region 16, inside the temporary accumulation region 17 and the storage compartment 13; and a pair of cross-link members 32 meant for driving the pressing member 31.

As illustrated in FIG. 3, the pressing member 31 is disposed to be movable to the following three positions: a standby position inside the loading region 16; a first forward movement position inside the temporary accumulation region 17; and a second forward movement position inside the storage compartment 13.

The external dimensions of the pressing member 31 are smaller than the distance between belt-type carrier paths 41 and 42 arranged in parallel (see FIGS. 6A and 6B), and are also smaller than the storage opening 13b of the storage compartment 13. As a result, the pressing member 31 becomes able to pass through the gap between the belt-type carrier paths 41 and 42 and through the storage opening 13b. Moreover, as illustrated in FIG. 4C, the pressing member 31 has a rectangular pressing face 31a that is sufficiently longer than the length of the short side of the bank bill 2. As a result, the pressing member 31 becomes able to properly press the bank bill 2, which has been loaded into the loading region 16, inside the temporary accumulation region 17 and the storage compartment 13.

As illustrated in FIGS. 4B and 4C, the two cross-link members 32 are rotatably coupled to each other via a rotation shaft 33. One end of one of the two cross-link members 32 is moved by a driving motor 44 (see FIGS. 5A and 5B), so that the two cross-link members 32 extend toward the storage compartment 13. As a result of the extension of the pair of cross-link members 32, the pressing member 31 is moved to the first forward movement position and the second forward movement position from the standby position.

### Configuration of Partitioning Members

As illustrated in FIGS. 3 and 4A, the holding member 12 of the bank bill storage device 11 includes a pair of partitioning members 34 that supports the bank bill 2 which has been moved to the temporary accumulation region 17. The two partitioning members 34 are formed in the shape of flat plates and, as illustrated in FIG. 3, are disposed side-by-side along the gap between the loading region 16 and the temporary accumulation region 17. The pair of partitioning members 34 is disposed to be rotatable to a partitioning position representing a first position and an open-up position representing a second position. At the partitioning position, the pair of partitioning members 34 partition the gap between the loading region 16 and the temporary accumulation region 17 as illustrated in FIG. 4A. At the open-up position, the pair of partitioning members 34 open up the gap between the loading region 16 and the temporary accumulation region 17 as illustrated in FIG. 4B.

As illustrated in FIGS. 4A and 4B, the pair of partitioning members 34 is rotatably supported by an opposed side wall 12c of the holding member 12. Each partitioning member 34 includes: a base end portion 35 provided with a shaft 35a that is rotatably supported by the side wall 12c of the holding member 12; and a front end portion 36 that is coupled to the base end portion 35. Meanwhile, the two partitioning members 34 are disposed with such a predetermined distance maintained therebetween that the pressing member 31 moving between the standby position and the first forward movement position becomes able to pass between the front end portions 36 which are opposite to each other at the partitioning position.

The front end portion 36 of each partitioning member 34 is formed to be elastically deformable. The base end portion 35 of each partitioning member 34 is formed using a rigid material and has the shape of a rectangular frame. Since the rigidity of the base end portion 35 is secured, it enables securing stability of the rotation around the shaft 35a. Moreover, the front end portion 36 of each partitioning member 34 is formed using an elastic material, such as a resin film or a rubber plate, in the shape of a rectangular plate, and is fixed to the base end portion 35.

In this way, the front end portion 36 of each partitioning member 34 is configured to undergo smooth elastic deformation at the time of coming in contact with the pressing member 31 or the bank bill 2; so that, when rotating from the partitioning position to the open-up position, the front end portion 36 does not block the forward movement of the pressing member 31 that is moving from the standby position to the first forward movement position. Since the front end portion 36 undergoes such elastic deformation, the pressing member 31 becomes able to stably carry the bank bill 2 from the loading region into the temporary accumulation region 17. Moreover, since the gap between the front end portions 36 of the two partitioning members 34 is maintained to be wide enough only to enable passage of the pressing member 31, the bank bill 2 inside the temporary accumulation region 17 can be stably held by the front end portions 36.

Moreover, the two partitioning members 34 are configured to move in tandem with the pressing mechanism 18. Thus, in tandem with the forward movement of the pressing member 31 from the standby position to the first forward movement position, the two partitioning members 34 are rotated from the partitioning position toward the open-up position. When the pressing member 31 moves to the first forward movement position, the two partitioning members 34 are moved to the open-up position by the pressing mechanism 18.

Alternatively, for example, the temporary holder 5 and the back-flow unit 6 can be formed in an integrated manner using the same material, and the front end portions 36 can be formed to have smaller thickness than the base end portions 35. With that, the front end portion of each partitioning member 34 can be formed to be elastically deformable. Meanwhile, the front end portion 36 of each partitioning member 34 is not limited to be formed using an elastic material. For example, the pair of partitioning members 34 can be disposed with such a distance maintained therebetween that, when the two partitioning members 34 rotate from the partitioning position to the open-up position, the pressing member 31 that moves forward toward the first forward movement position does not come in contact with the front end portions 36. In that case, the base end portion 35 and the front end portion 36 of each partitioning member 34 can be formed in an integrated manner using a rigid material.

Meanwhile, although not illustrated in the drawings, the pair of partitioning members 34 is not limited to have a rotating configuration. Alternatively, for example, the pair of partitioning members 34 can be configured to be slidable along the gap between the loading region 16 and the temporary accumulation region 17 and in the direction in which the front end portions 36 approach and move away from each other. Still alternatively, the pair of partitioning members 34 can be configured to move up and down with respect to a plate member 42e of the carrier unit 40. With that, the pair of partitioning members 34 can avoid going by the pressing member 31 at the time of moving between the partitioning position and the open-up position. Moreover, in this configuration, it becomes possible to use a single partitioning member disposed across the space between the loading region 16 and the temporary accumulation region 17, and to enhance the stability of the state in which the bank bill 2 is held inside the temporary accumulation region 17.

### Configuration of Carrier Unit

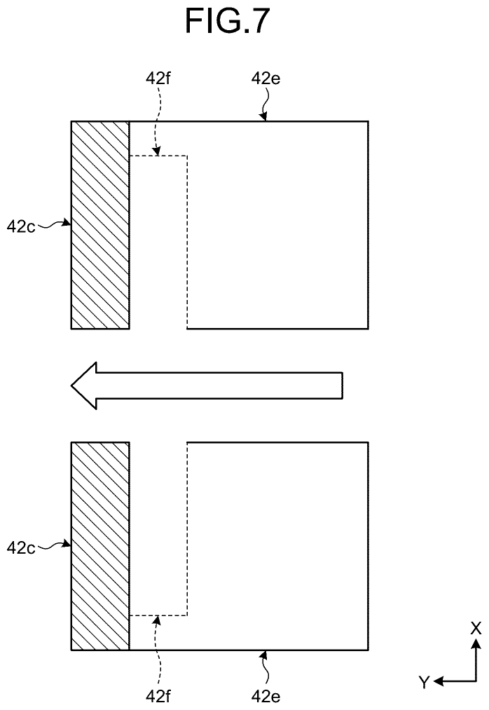

FIGS. 5A and 5B are schematic diagrams illustrating a lateral face of the carrier unit 40 in the bank bill storage device 11 according to the embodiment. FIGS. 6A and 6B are schematic diagrams illustrating the top face of the carrier unit 40 in the bank bill storage device 11 according to the embodiment. FIG. 7 is a schematic diagram illustrating the bottom face portion of the carrier unit 40 in the bank bill storage device 11 according to the embodiment.

As illustrated in FIG. 5A, under the control performed by a control unit (not illustrated), the carrier unit 40 drives a driving motor (not illustrated) and, in the state in which at least a single pair of the belt-type carrier paths 41 and 42 is abutting against both sides of the bank bill 2, carries the bank bill 2, which has been sent from the upper side, to the standby position. Then, under the control performed by the control unit, the driving motor 44 of the pressing mechanism 18 is driven, so that the bank bill 2 that has been carried to the standby position is held inside the storage compartment 13. Meanwhile, when the bank bill 2 is not to be held in the storage compartment 13 using the pressing mechanism 18, the carrier unit 40 carries the bank bill 2 to a lower position than the standby position, discharges the bank bill 2 through an opening 42f, and carries the bank bill 2 to a holding member present at a lower level.

In the belt-type carrier path 41, a carrier belt 41b is wound around rollers 41a that are supported by a supporting member 41c. In an identical manner, in the belt-type carrier path 42, a carrier belt 42b is wound around rollers 42a that are supported by a supporting member 42c. In the belt-type carrier paths 41 and 42, the rollers 41a and 42a are rotary-driven by a driving motor (not illustrated), so that the carrier belts 41b and 41b are moved in the carrying direction of the bank bill 2.

Thus, the bank bill 2 is carried in the state of being sandwiched on both sides by the carrier belt 41b of the belt-type carrier path 41 and the carrier belt 42b of the belt-type carrier path 42, that is, in the state of being abutted on both sides by the carrier belts 41b and 42b (hereinafter, called the abutted state). In the carrier unit 40, as a result of carrying the bank bill 2 in this manner, the wrinkles on the bank bill 2 can be smoothed out and the bank bill 2 having no deformation can be achieved.

More particularly, as illustrated in FIG. 6A, in the carrier unit 40, two pairs of carrier belts, each having a pair of the rollers 41a and 42b, are arranged in parallel and with a distance maintained therebetween. The two pairs of carrier belts carry the bank bill 2 while supporting both ends of the bank bill 2, that is, while sandwiching both sides of the bank bill 2 at both ends. Through the gap present between the two pairs of carrier belts, the pressing member 31 of the pressing mechanism 18 presses the bank bill 2 into the storage compartment 13.

As illustrated in FIGS. 5A, 5B, and 6A, the following elements are disposed on the supporting member 41c: a cam 44b that is powered by a belt 44a which transmits the power of the driving motor 44 meant for driving the pressing mechanism 18; and a tensile spring 43 that is linked to the supporting member 42c.

As illustrated in FIG. 5A, the supporting member 42c is connected, in its upper part, to a rotation fulcrum 42d; and is connected, in its lower part, to the supporting member 41c via the tensile spring 43. As a result, the belt-type carrier path 42 becomes able to perform rotational transfer around the rotation fulcrum 42d. When no particular external force is exerted, the abutted state in which the bank bill 2 is sandwiched from both sides is maintained due to the elasticity of the tensile spring 43. At the time when the pressing mechanism 18 presses the bank bill 2, which has been carried to the standby position, into the storage compartment 13; an external force is applied to the belt-type carrier path 42 for causing rotational transfer of the belt-type carrier path 42 around the rotation fulcrum 42d. As a result, the carrying belt 42b is released from the abutted state with respect to the bank bill 2.

More particularly, as illustrated in FIG. 5B, at the time when the pressing mechanism 18 presses the bank bill 2 into the storage compartment 13, the power of the driving motor 44, which is used to drive the pressing mechanism 18, gets transmitted to the cam 44b via the belt 44a. Because of that power, the cam 44b rotates and the apex portion thereof applies an external force onto the belt-type carrier path 42 in such a way that the supporting member 41c is pushed up. At the time when the pressing mechanism 18 presses the bank bill 2, because of the external force exerted on the carrier unit 40, the carrying belt 42b is released from the abutted state with respect to the bank bill 2.

Thus, the driving motor 44, the belt 44a, and the cam 44b represent an example of an inter-dependent mechanical system by which pressing of the bank bill 2 is performed in tandem with releasing the abutted state with respect to the bank bill 2. Meanwhile, the inter-dependent mechanical system is not limited to be a combination of the driving motor 44, the belt 44a, and the cam 44b; and can alternatively be a combination with a crank mechanism.

As illustrated in FIG. 6B, after being released from the abutted state, the bank bill 2 becomes folded in two due to the pressing action attributed to the pressing face 31a of the pressing member 31; passes through the gap between the two pairs of carrier belts; and is pressed into the storage compartment 13. Because of such pressing, the bank bills 2 are stored in the storage compartment 13 without leaving any space therebetween.

As illustrated in FIGS. 5A, 5B, and 7, in the lower part of the supporting member 42c, the plate member 42e is disposed to be orthogonal to the supporting member 42c. At the position corresponding to the carrying route (an arrow illustrated in FIG. 5A) along which the bank bill 2 is carried by the belt-type carrier paths 41 and 42, the plate member 42e includes an opening 42f that has a larger shape than the outer size of the bank bill 2 and that allows passage of the bank bill 2.

As illustrated in FIG. 5B, the plate member 42e works in tandem with the supporting member 42c. Hence, in tandem with the release of the abutted state with respect to the bank bill 2, the position of the opening 42f, which allows passage of the bank bill 2, gets sidelined from the carrying route of the bank bill 2. As a result, after being released from the abutted state, even if the bank bill 2 falls freely in, for example, the Z direction, it gets supported by the plate member 42e, and hence does drop out from the opening 42f. That is, the release of the abutted state of the bank bill 2 and the pressing of the bank bill 2 inside the storage compartment 13 can be performed in a smooth manner.

As explained above, the bank bill storage device 11 includes the holding member 12, the storage compartment 13, the carrier unit 40, and the pressing mechanism 18. The holding member 12 includes the loading region 16 in which the bank bill 2 is loaded. The storage compartment 13 is disposed adjacent to the holding member 12, and is used to store the bank bill 2. In the state in which at least a single pair of carrier belts 41b and 42b of the carrier unit 40 remain abutted to both sides of the bank bill 2, the carrier unit 40 carries the bank bill 2 into the loading region 16. The pressing mechanism 18 presses the bank bill 2, which is carried into the loading region 16, inside the storage compartment 13. When the pressing mechanism 18 presses the bank bill 2, the carrier unit 40 releases one of the carrier belts 41b and 42b from the abutted state with respect to the bank bill 2. As a result, in the bank bill storage device 11, the bank bills 2 can be stored in the storage compartment 13 without any deformation such as wrinkles and without having any spaces left therebetween.

Moreover, in the bank bill storage device 11, the carrier unit 40 carries the bank bill 2 in the state in which two pairs of carrier belts, which are arranged in parallel and with a distance maintained therebetween, remain abutted against the two ends of the bank bill 2. The pressing mechanism 18 presses the bank bill 2 through the gap between the two pairs of carrier belts. As a result, it becomes possible to store, inside the storage compartment 13, the bank bill 2 that has been carried without any deformation such as wrinkles up to the loading region 16 by the two pairs of carrier belts.

The bank bill storage device 11 further includes an inter-dependent mechanical system that works in tandem with the release of the abutted state of one of the carrier belts with respect to the bank bill 2. As a result, in the bank bill storage device 11, the pressing of the bank bill 2 and the release of the abutted state with respect to the bank bill 2 can be achieved using, for example, a single driving motor 44 without having to provide separate motors representing driving sources.

Moreover, in the bank bill storage device 11, the carrier unit 40 includes the plate member 42e having the opening 42f formed thereon to allow passage of the bank bill 2. In the inter-dependent mechanical system, in tandem with the release of the abutted state of one of the carrier belts with respect to the bank bill 2, the plate member 42e is moved in such a way that the opening 42f is positioned away from the carrying route of the bank bill 2. As a result of sidelining the position of the opening 42f from the carrying route of the bank bill 2 in tandem with the release of the abutted state, the bank bill 2 that has been released from the abutted state is held back from being carried to the outside.

According to an aspect of the paper sheet storage device disclosed in the application concerned, paper sheets can be stored in a more systematic manner.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A paper sheet storage device comprising:
a holding member that includes a loading region into which a paper sheet is loaded;
a storing member that is disposed adjacent to the holding member and that is used to store the paper sheet;
a carrier unit that, in a state in which at least a single pair of carrier belts is abutting against both sides of the paper sheet, carries the paper sheet into the loading region; and
a pressing mechanism that presses the paper sheet, which has been carried into the loading region, inside the storing member, wherein
at the time of pressing of the paper sheet by the pressing mechanism, the carrier unit releases abutment of one of the carrier belts with respect to the paper sheet.

2. The paper sheet storage device according to claim 1, wherein
the carrier unit carries the paper sheet in a state in which two pairs of the carrier belts, which are arranged in parallel and with a distance maintained therebetween, remain abutted against two ends of the paper sheet, and
the pressing mechanism presses the paper sheet through a gap between the two pairs of the carrier belts.

3. The paper sheet storage device according to claim 1, further comprising an inter-dependent mechanical system to ensure that pressing of the paper sheet is performed in tandem with releasing abutment of one of the carrier belts with respect to the paper sheet.

4. The paper sheet storage device according to claim 3, wherein
the carrier unit includes a plate material on which an opening is formed for allowing passage of the paper sheet, and
in tandem with releasing abutment of one of the carrier belts with respect to the paper sheet, the inter-dependent mechanical system moves the plate member in such a way that the opening is positioned away from carrying route of the paper sheet.
